(19) United States
(12) Patent Application Publication
(10) Pub. No.: US 2010/0301866 A1
(43) Pub. Date: Dec. 2, 2010

(54) Capacitive Detection System

(75) Inventors: Dustin Blessum, Perry, OK (US); Michael F. Gard, Perry, OK (US)

Correspondence Address: TOMLINSON & O'CONNELL, P.C., TWO LEADERSHIP SQUARE, 211 NORTH ROBINSON, SUITE 450, OKLAHOMA CITY, OK, 73102, US

(73) Assignee: The Charles Machine Works, Inc., Perry, OK (US)

(21) Appl. No.: 12/788,962

(22) Filed: May 27, 2010

Related U.S. Application Data
(60) Provisional application No. 61/181,501, filed on May 27, 2009.

(51) Int. Cl. G01V 3/18; G01V 3/20; E21B 47/09

(52) U.S. Cl. 324/326; 324/356; 175/40

(57) ABSTRACT

An apparatus for detecting and avoiding an underground object during a horizontal directional drilling operation. The apparatus comprises a boring tool with a capacitive detection system. The boring tool is operatively connected to a drill string and advanced through the earth to create a borehole. The capacitive detection system includes a capacitive assembly and a processor. The capacitive assembly has first and second capacitive plates separated a known distance from an excitation plate. The capacitive plates detect a change in capacitance when the underground object is approached by the boring tool. The processor determines the distance to or location of the underground object from capacitance information sensed by the capacitive detection system. The distance and location information is transmitted to a machine operator.

### CROSS REFERENCE TO RELATED APPLICATIONS

This application claims priority of U.S. Provisional Patent Application No. 61/181,501 filed May 27, 2009, the content of which is incorporated fully herein by reference.

### FIELD OF THE INVENTION

The present invention relates to improved apparatus and method for detection and avoidance of underground obstacles during Horizontal Directional Drilling (HDD) applications, and more particularly to drill bits for use in detecting underground objects.

### SUMMARY OF THE INVENTION

The present invention is directed to an apparatus for locating an underground object. The apparatus comprises a drill string, a boring tool, a capacitive assembly, and a processor. The drill string has a first end. The boring tool is operatively connected to the first end of the drill string. The capacitive assembly is disposed proximate the boring tool and is adapted to detect capacitance changes. The processor is adapted to detect the underground object using the capacitance change detected by the capacitive assembly.

In an alternative embodiment the present invention is directed to an apparatus for locating an underground object. The apparatus comprises a drill string having a first end, a boring tool operatively connected to the first end of the drill string and having a longitudinal axis, a capacitive assembly disposed proximate the boring tool, and a processor adapted to detect the underground object using a capacitance change detected by the capacitive assembly. The capacitive assembly comprises a back plane comprised of copper, a first capacitive plate and a second capacitive plate, the first plate secured to a first end of the back plane and the second plated secured to a second end of the back plane, and an excitation plate. The first plate and the second plate are disposed transverse to the longitudinal axis of the boring tool.

In yet another embodiment, the present invention is directed to a boring tool for use in horizontal direction drilling. The tool comprises a boring tool body having a longitudinal axis and adapted to be connectable to a drill string, a capacitive assembly, and a processor. The capacitive assembly comprises a back plane comprised of copper, a first capacitive plate and a second capacitive plate, the first plate secured to a first end of the back plane and the second plated secured to a second end of the back plane, and an excitation plate. The processor is adapted to detect the underground object using a capacitance change detected by the capacitive assembly.

### BRIEF DESCRIPTION OF THE DRAWINGS

FIG. 1 is a side view of an HDD machine drilling in the presence of existing underground obstacles with the aid of a capacitive detection system of the present invention.

FIG. 2 is a sectional side view of a drill bit for use with the present invention.

FIG. 3 is a top view of the drill bit of FIG. 3.

FIG. 4 perspective view of the capacitive detection assembly used in the drill bit of FIG. 3.

### DETAILED DESCRIPTION OF THE DRAWINGS

One of the greatest threats in the Horizontal Directional Drilling (“HDD”) is the possibility of striking an existing utility. Identification of non-metallic lines (such as polyethylene gas lines and PVC water lines) in particular is extremely difficult. The present invention uses capacitive sensing elements to detect buried lines or other objects by measuring capacitance. Generally, capacitive sensing elements involve some configuration of two or more plates in a selected configuration. If two plates are constrained to a fixed area and a fixed separation distance, the capacitance will change or vary only when there is a change in dielectric material between and surrounding the plates.

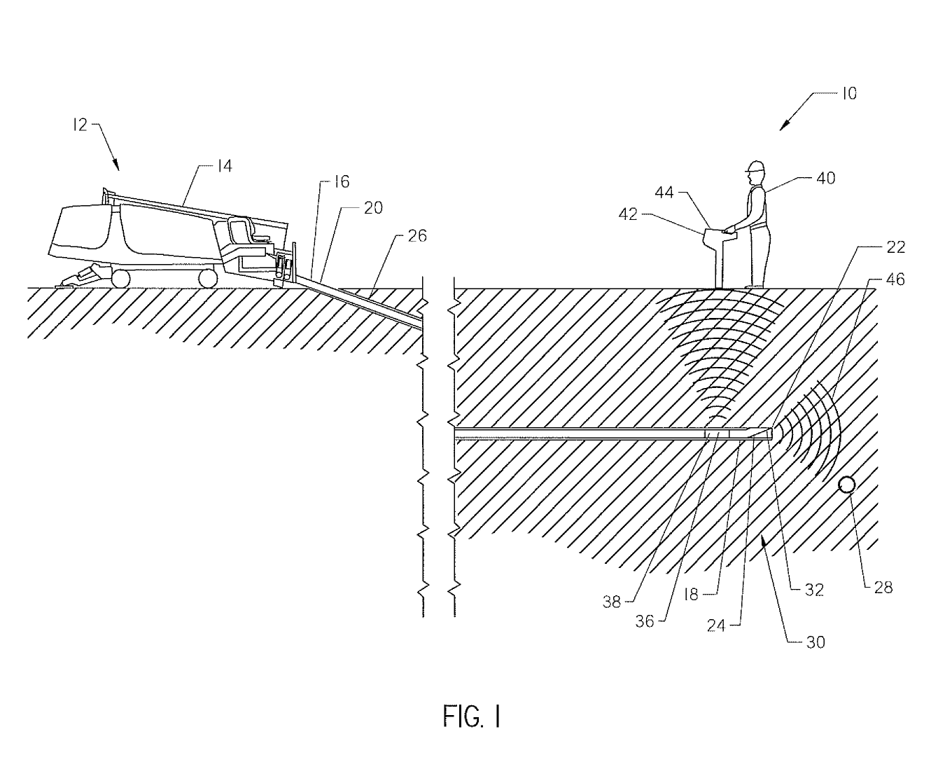

Turning now to the drawings and to FIG. 1 in particular, shown therein is a preferential embodiment of Horizontal Boring System 10. The system 10 is shown for use with a HDD unit 12, the unit comprising a drilling machine 14, a drill string 16 and a downhole tool 18. The HDD unit 12 of the present invention is suitable for near-horizontal subsurface placement of utility services, for example under a roadway, building, river, or other obstacle. The drilling machine 14 is operatively connected to the drill string 16 at an uphole end 20 of the drill string 16. The downhole tool assembly 18 is operatively connected to a downhole end 22 of the drill string 16. The downhole tool 18 may be any of a variety of tools suitable for use during an HDD operation. For discussion purposes and as shown in FIG. 1, the downhole tool 18 comprises a directional drill bit 24.

FIG. 1 illustrates the usefulness of HDD operations by demonstrating that a borehole 26 can be made without disturbing an above-ground structure, for example a roadway or walkway. Typically HDD operation begins by planning a bore path for placement of the utility. To cut or drill the borehole 26, the drill string 16 carrying the downhole tool 18 is rotationally driven by the drilling machine 14. When the HDD unit 12 is used for drilling a borehole 26, monitoring the position of the downhole tool 18 is critical to accurate placement of the borehole and subsequently installed utilities.

The Horizontal Boring System 10 of the present invention is equipped for use in discovering underground objects 28, whether known or unknown. The underground object 28 can be a buried utility or similar line, but the system 10 may also be used for locating other buried objects. The object 28, if encountered, may complicate the operation of the HDD unit 12. For example, a drill head 24 striking a utility line may lead to loss of services in nearby buildings and dangerous conditions in the area of the strike. Some objects 28 are unknown at the time of drilling, while others are known but the precise location of the objects with respect to the advancing downhole tool 18 is unknown.

With continued reference to FIG. 1, the system 10 comprises a capacitive detection system 30. The detection system 30 is preferably positioned proximate the drill bit 24. The detection system 30 comprises a capacitive assembly 32, a communication transmitter 36, and a processor 38. The detection system 30 functions to detect the object 28 and may communicate information concerning the object to an operator 40 at an above ground location. The operator 40 receives the information at a receiving unit 42 preferably including a display 44. In an alternative embodiment, the information concerning the object may be communicated to the HDD unit 12 by way of a cable or other communication system using the drill string 16.

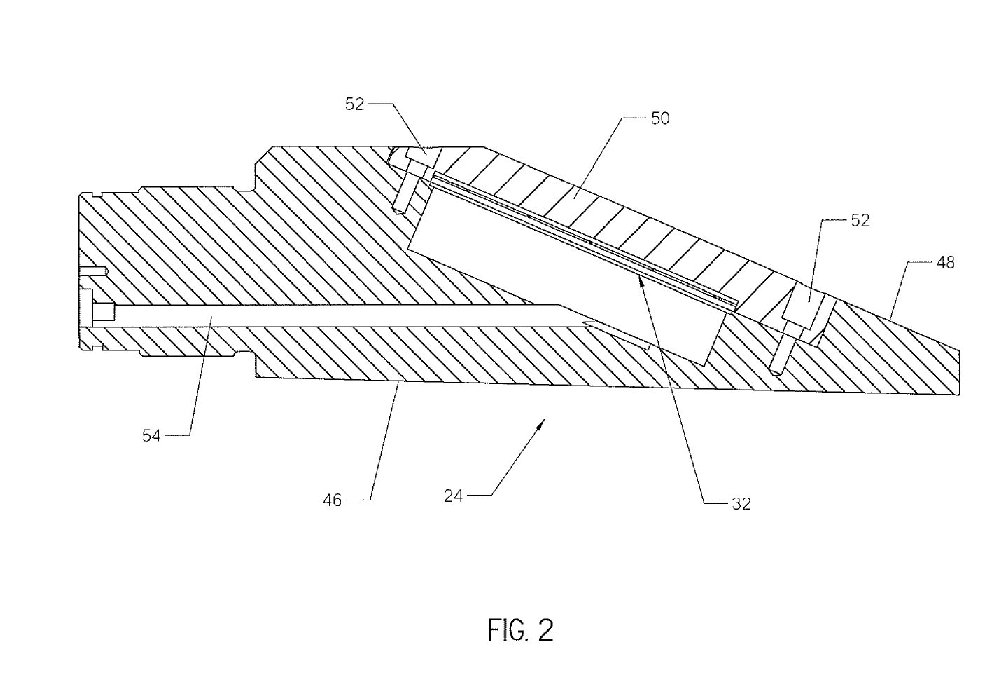

Turning now to FIG. 2, shown therein is a side view of the drill bit 24. The drill bit comprises a body 46 having a longitudinal axis. Preferably, the drill bit 24 comprises a slant face 48 proximate a forward end of the bit. The slant face 48 allows for steering of the drill bit 24 and the drill string 16. The capacitive assembly 32 is preferably disposed along the slant face 48. More preferably, a ceramic plate 50 is secured with a plurality of bolts 52 and is used to maintain the capacitive assembly 32 in position along the slant face 48. Most preferably, a void is present behind the capacitive assembly 32 to facilitate operation of the assembly. The drill bit 24 may also comprise a cable passage 54 for connection of the capacitive assembly 32 to the processor 38.

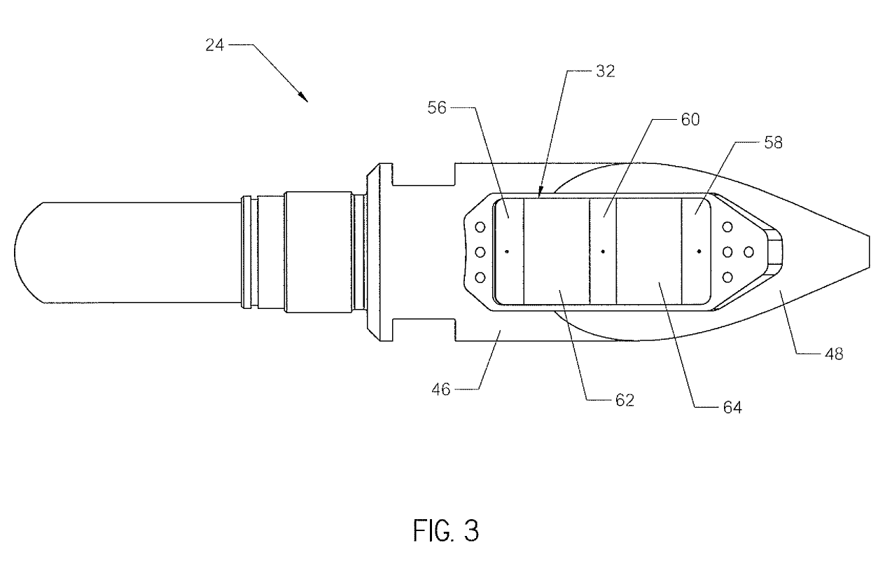

With reference now to FIG. 3, a top view of the drill bit 24 showing the capacitive assembly 32 without the ceramic plate 50 is shown. The capacitive assembly 32 preferably comprises a plurality of capacitive sensing plates 56 and 58 and an excitation plate 60. The excitation plate 60 is disposed between the plates 56 and 58. Preferably, the capacitive plates 56 and 58 are further separated by a plurality of fixed dielectric plates 62 and 64. More preferably, the fixed dielectric plates 62 and 64 are comprised of fiberglass or other suitable material.

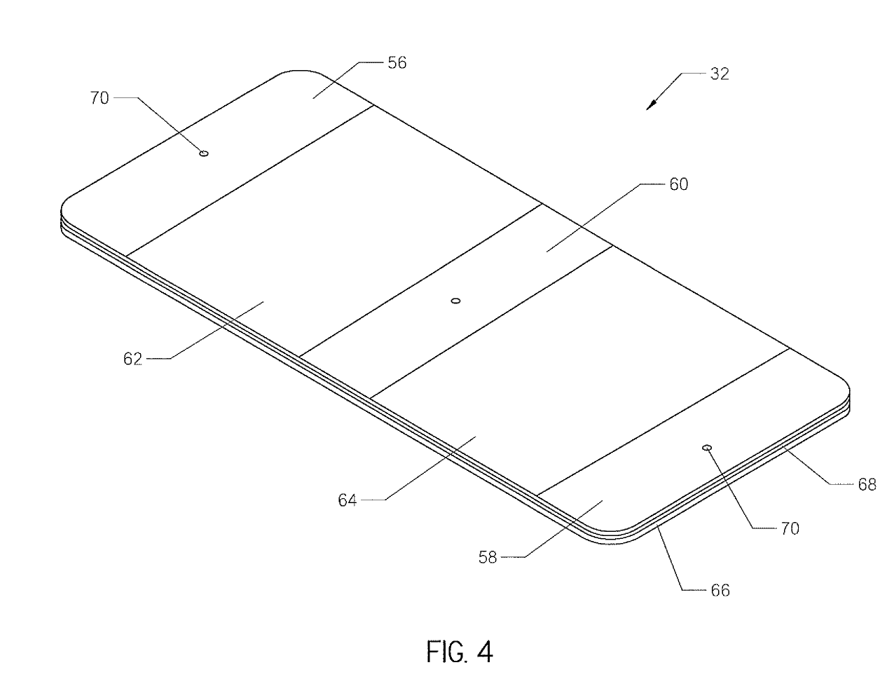

The capacitive assembly 32 is shown in greater detail in FIG. 4. The capacitive assembly 32 is preferably longitudinal and adapted to fit adjacent the slant face 48 of the drill bit 24. The assembly 32 comprises a spacer base plate 66 and a copper back plane 68. The capacitive plates 56 and 58 and the excitation plate 60 are secured to a surface of the copper back plane 68. Preferably, the plate 56 is disposed at a first end of the assembly 32 and the second plate 58 is disposed at a second opposite ends of the assembly 32. More preferably, the plates 56 and 58 are disposed transverse to the longitudinal axis of the drill bit 24. The excitation pulse plate 60 is centered between the plates 56 and 58, and also transverse to the longitudinal axis. The plates 56 and 58 can be separated a known distance using the dielectric plates 62 and 64. Distance between the plates 56 and 58 may be adjusted or selected to assist with power and detection capabilities. A plurality of vias 70 are used to connect the plates 56 and 58 and the excitation plate 60 to a capacitance-to-digital convert and support electronics at the processor 38.

The first capacitive sensing plate 56, the second capacitive sensing plate 58, and the excitation plate 60 are formed of conductive material characterized by high electrical conductivity (low electrical resistance). A first capacitive sensing plate 56, the second capacitive sensing plate 58, and the excitation plate 60 are supported on a first side of a relatively thin, generally rectangular, first dielectric substrate formed of material with very low electrical conductivity (high electrical resistance). Supported in this way, the plates 56, 58, and 60 are separated by the dielectric plates 62 and 64 that are a part of the dielectric substrate. The first dielectric substrate is substantially an insulator, preferably with low dielectric permittivity (low relative permittivity). A second, opposite, side of the relatively thin first dielectric substrate supports a second thin conductive layer having high electrical conductivity (low electrical resistance), preferably comprised of a metal deposition. The second thin conductive layer (or backplane 68) is electrically isolated from the first capacitive sensing plate 56, the second capacitive sensing plate 58, and the excitation plate 60. The second thin conductive layer 60 is used as the capacitive assembly's 32 reference electrode. The second thin conductive layer 60 may be called the reference electrode or backplane, which are to be understood as equivalent names for the same structure.

In the preferred embodiment, the capacitive sensing assembly 32 begins as a piece of double-sided circuit board material (typically fiberglass or polyimide material well-known in the electrical arts) bearing continuous planar copper depositions on both sides of the circuit board material. In the preferred embodiment the first capacitive sensing plate 56, the second capacitive sensing plate 58, and the excitation plate 60 are formed by selective chemical etching or selective mechanical removal of copper from the first side of the double-sided circuit board material to form generally rectangular planar structures which constitute the first and second capacitive sensing plates and the excitation plate.

The second thin conductive layer is the reference electrode or backplane 68 of the capacitive assembly 32. Electrical potential on the first 56 and second 58 sensing plates are measured with respect to the reference electrode or backplane 60 (the second thin conductive layer), and the excitation signal is applied to the excitation plate 60 and referenced to the reference electrode. The second thin conductive layer 60 (reference electrode) is electrically isolated from the metal of the drill bit by the second dielectric substrate 66 which is electrically insulating.

The first capacitive sensing plate 56, the second capacitive sensing plate 58, and the excitation plate 60 are, in the preferred embodiment, generally rectangular elements of conductive material disposed so as to be generally transverse to the longitudinal axis of the drill bit 24 and the drill string 16. The use of generally rectangular elements is a matter of design convenience. A great many geometrical arrangements are possible and the use of generally rectangular elements of conductive material in the preferred embodiment is not to be understood as a limitation of the invention. The geometry and number of electrodes may be manipulated to obtain response patterns emphasizing certain orientations.

The previously described first and second sensing plate structures, acting with the previously described reference or backplane electrode, constitute the plates of two capacitors embedded in the medium surrounding the drill bit and the capacitive sensing assembly. While the capacitor plates formed by the sensing plate and reference electrode structures have rigidly defined geometries, the dielectric constant of the surrounding medium influences the effective capacitances of the capacitors of the capacitor assembly. A change in the dielectric constant (relative permittivity) of a fixed-geometry plate capacitor results in corresponding changes in the effective capacitances of the capacitors according to relationships well known to those skilled in the electrical arts.

When a time-varying signal source—typically, but not necessarily, a pulse sequence—is applied to the excitation plate, voltages appear across the sensing plates (relative to the reference electrode) in accordance with the capacitances of the sensing structure capacitances. As the effective dielectric constant of the surrounding medium changes, the sensing plate capacitances change and the voltages appearing across the sensing plates also change. The difference of these two sensing plate signals highlights, or exaggerates, the capacitive differences between the two sensing plates, making the differential voltage response of the two sensing plate capacitances very sensitive to localized changes in the effective dielectric constant of the surrounding medium. The differential voltage responses of the two sensing plate capacitors may then be processed to indicate the possible presence of an object, disturbed soil, or a subsurface void. Such dielectric heterogeneities may be indicative of a buried object or, more generally, of some sort of previous man-made disturbance.

The processor 38 receives electronic data from the capacitive plates 56 and 58 indicative of change in the capacitance. Preferably, a change in capacitance is correlated to a distance to or location of the object 28 by the processor 38. Additional software can be used for software filtering and data preservation. The transmitter 36 is operatively connected to the processor 38 and is adapted to transmit the processed information about the object 28 to the receiving unit 42. At the receiving unit 42, the display 44 may be used to display the information about the object 28 so that it can be accessed by the operator 40.

Various modifications can be made in the design and operation of the present invention without departing from the spirit thereof. Thus, while the principal preferred construction and modes of operation of the invention have been explained in what is now considered to represent its best embodiments, which have been illustrated and described, it should be understood that the invention may be practiced otherwise than as specifically illustrated and described.

What is claimed is:

1. An apparatus for locating an underground object comprising:
a drill string having a first end;
a boring tool, operatively connected to the first end of the drill string, the boring tool having a longitudinal axis;
a capacitive assembly disposed proximate the boring tool and adapted to detect a capacitance change; and
a processor adapted to detect the underground object using a capacitance change detected by the capacitive assembly.

2. The apparatus of claim 1, wherein the capacitive assembly comprises:
a back plane;
a plurality of capacitive plates; and
an excitation plate.

3. The apparatus of claim 2 wherein the back plane is comprised of copper.

4. The apparatus of claim 2 wherein the plurality of capacitive plates comprises a first plate and a second plate, the first plate disposed at a first end of the back plane and the second plate disposed at an opposite second end of the back plane.

5. The apparatus of claim 4, wherein the first plate and the second plate are disposed transverse to the longitudinal axis of the boring tool.

6. The apparatus of claim 4 wherein the capacitive assembly comprises a first dielectric plate and a second dielectric plate;
wherein the first dielectric plate is disposed between the first capacitive plate and the excitation plate; and
wherein the second dielectric plate is disposed between the second capacitive plate and the excitation plate.

7. The apparatus of claim 1 wherein the processor is adapted to determine a distance to the underground object using the capacitance change detected by the capacitive assembly.

8. The apparatus of claim 7 further comprising a wireless system adapted to transmit the distance to the underground object.

9. An apparatus for locating an underground object comprising:
a drill string having a first end;
a boring tool, operatively connected to the first end of the drill string, the boring tool having a longitudinal axis;
a capacitive assembly disposed proximate the boring tool, the capacitive assembly comprising:
a back plane comprised of copper;
a first capacitive plate and a second capacitive plate, the first plate secured to a first end of the back plane and the second plated secured to a second end of the back plane; and
an excitation plate; and
a processor adapted to detect the underground object using a capacitance change detected by the capacitive assembly;
wherein the first plate and the second plate are disposed transverse to the longitudinal axis of the boring tool.

10. The apparatus of claim 9 wherein the capacitive assembly comprises a first dielectric plate and a second dielectric plate;
wherein the first dielectric plate is disposed between the first capacitive plate and the excitation plate; and
wherein the second dielectric plate is disposed between the second capacitive plate and the excitation plate.

11. A boring tool for use in horizontal direction drilling, the tool comprising:
a boring tool body having a longitudinal axis, the body connectable to a drill string;
a capacitive assembly comprising:
a back plane comprised of copper;
a first capacitive plate and a second capacitive plate, the first plate secured to a first end of the back plane and the second plated secured to a second end of the back plane; and
an excitation plate; and
a processor adapted to detect the underground object using a capacitance change detected by the capacitive assembly.

12. The boring tool of claim 11 wherein the boring tool body comprises a slant face.

13. The boring tool of claim 11 wherein the capacitive assembly is disposed adjacent the slant face.

14. The boring tool of claim 11 wherein the first plate and the second plate are disposed transverse to the longitudinal axis of the boring tool.
